(19) United States
(12) Patent Application Publication
(10) Pub. No.: US 2025/0244614 A1
(43) Pub. Date: Jul. 31, 2025

(54) Magnetically Detectable Safety Glasses

(71) Applicant: David Smith, Collierville, TN (US)

(72) Inventor: David Smith, Collierville, TN (US)

(21) Appl. No.: 19/042,803

(22) Filed: Jan. 31, 2025

Related U.S. Application Data
(60) Provisional application No. 63/627,308, filed on Jan. 31, 2024.

(51) Int. Cl. G02C 11/00; G02C 1/06

(52) U.S. Cl. CPC G02C 11/00; G02C 1/06

(57) ABSTRACT

A pair of glasses, advantageously used as safety glasses in a manufacturing environment, which includes a novel metal clip component which is securely embedded in a portion of such glasses. In preferred embodiments, the inventive metal clip component is roughly U-shaped with ridges at each tip thereof, such that the inventive metal clip is securely fixed at a given location within said safety glasses upon being applied and cannot back out or be loosened under conditions of normal use.

### CROSS-REFERENCE TO RELATED APPLICATIONS

The This nonprovisional application claims the benefit of priority under 35 USC § 119 to U.S. Patent Application No. 63/627,308, filed on Jan. 31, 2024, the entirety of which is incorporated herein by reference.

### BACKGROUND OF THE INVENTION

### Field of the Invention

The invention relates primarily to personal protective equipment, and more specifically, to innovative, metal detectable safety glasses which can be more readily detected in manufacturing settings, such as in a food processing production line.

### Description of the Background

The food industry, like many industries, requires production line personnel to use safety equipment, sometimes referred to as personal protective equipment (“PPE”). PPE is not only used for the safety of production line personnel, but also to protect the production line equipment, for which damage and/or a service interruption can be costly, and, of course, for the safety of the end user and compliance with food safety standards.

In particular, most, if not all, primary articles of PPE are designed to be “easy on and off”, such that they can be donned when the user is on the production line and removed when the user exits the production area, often multiple times per day. This helps maintain the cleanliness of the production area, by preventing contaminants from outside of the production facility to be carried into the production facility on the surfaces of such PPE.

One of the more common types of PPE, which are used in the food production industry but also across many other industrial fields, are safety glasses. Existing safety glasses are designed with a few primary goals in mind: (1) to protect the eyes of the wearer from contact by foreign objects, including dust or splatter from liquids; (2) to protect the eyes of the wearer from UV light; (3) to withstand heavy wear and tear such as may be encountered during daily use in a production facility; (4) to make the user more easily identifiable in low visibility work environments; (5) improve user visibility; and/or (6) to limit the potential for contamination to the production line from small objects or fluids in or around the user's eyes (like tears, eyelashes, etc.). For this reason, conventional safety glasses are generally comprised primarily of a clear polymeric material, which allows the user to see clearly through them, while simultaneously providing a barrier (in both directions) from contaminants. These materials are also generally fairly capable at withstanding the wear and tear of a production environment, and relatively cheap to obtain.

At the same time, however, materials of the type most frequently used in existing safety glasses, including polymers such as plastic, and of course, glass, are breakable under conditions of the type commonly encountered in production environments. Moreover, when materials of this type break, they often shatter into relatively small, and typically sharp, pieces, as opposed to making a clean break in a larger chunk. From a practical standpoint, this means that small, likely sharp pieces of a hard material such as glass or plastic could be dispersed if a pair of safety glasses is broken. In the food industry, such pieces may end up in production equipment, potentially damaging equipment or, worse, ending up in a food product.

Recognizing the general problem of the potential for harmful materials (including hardware and other items of metal from the production line) to end up in food products during production, the prior art has proposed the use of magnets in an attempt to detect foreign objects made of metal in production lines and/or food products. In addition, U.S. Pat. No. 11,690,762 to Love et al. (“Love”) has proposed to form a portion of a pair of safety glasses from a metal strip in order to enable the glasses to be detectable by a magnet, if used on a production line. However the product disclosed by Love suffers from the drawback that additional materials are needed in order to encapsulate and enclose the metal portion of those glasses such that it is secured during normal use and does not fall off of the user/onto the production line under ordinary circumstances.

### SUMMARY OF THE INVENTION

It would therefore be useful and advantageous to have a PPE device, or a pair of safety glasses in particular, which had a metal component which was securely embedded in a primary portion of said device, such that it could be detectable by metal detectors used on or in connection with a production line, such as a food production line.

It would also be advantageous to have such a device in which the amount of metal utilized to make the primary portion of a pair of PPE detectable by a magnet was minimized, to make such device more cost effective.

The present invention is therefore a pair of glasses, advantageously used as safety glasses in a manufacturing environment, which includes a novel metal clip component which is securely embedded in a portion of such glasses. In preferred embodiments, the inventive metal clip component is roughly U-shaped with ridges at each tip thereof, such that the inventive metal clip is securely fixed at a given location within said safety glasses upon being applied and cannot back out or be loosened under conditions of normal use.

Thus, it is another advantage of the present invention that the inventive metal detectable safety glasses do not require additional reinforcing material to retain the inventive metal clip portion therein.

The foregoing objects, features and attendant benefits of this invention will, in part, be pointed out with particularity and will become more readily appreciated as the same become better understood by reference to the following detailed description of a preferred embodiment and certain modifications thereof when taken in conjunction with the accompanying drawings.

### BRIEF DESCRIPTION OF THE DRAWINGS

In the drawings:

FIG. 1 is a rear view of the novel metal detectable glasses of the present invention.

FIG. 2 is a front, top, left perspective view of the novel metal clip component of the present invention, viewed in isolation.

FIG. 3 is a left side view of the novel metal clip component of the present invention, viewed in isolation

FIG. 4 is a rear perspective view of the novel metal detectable glasses of the present invention, without the temple portions.

### DETAILED DESCRIPTION OF THE PREFERRED EMBODIMENTS

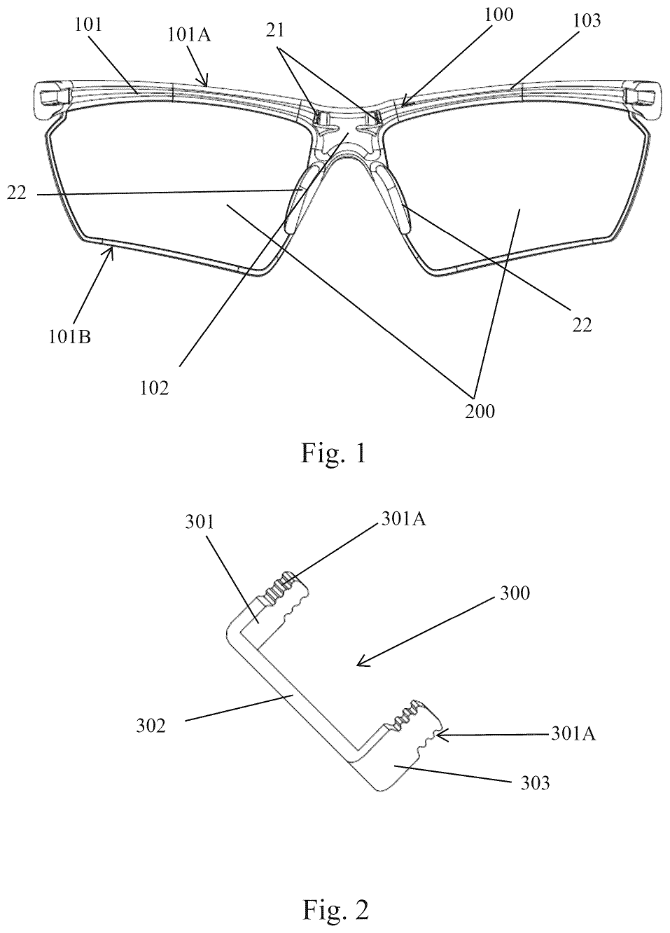

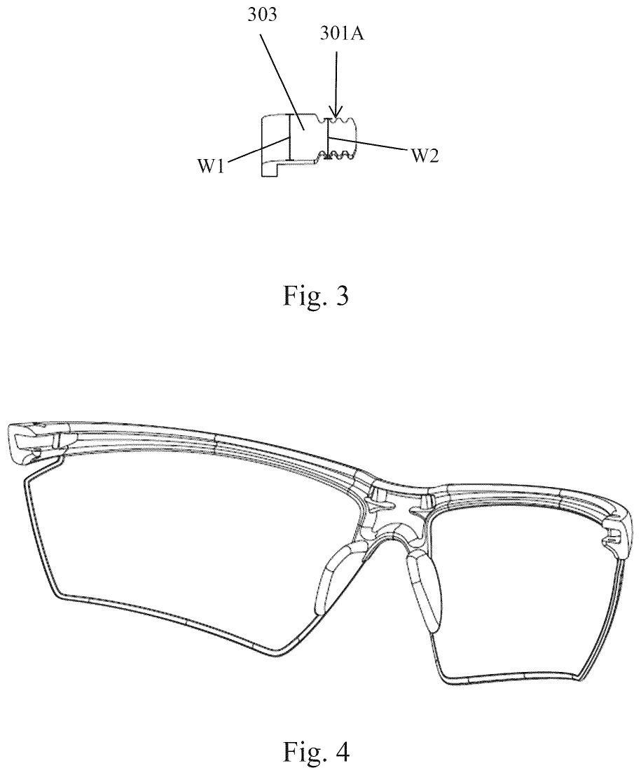

FIGS. 1 and 4 show rear, and rear perspective views, respectively, of the novel safety glasses according to the present invention. The primary components of such glasses can include a thin, elongate frame 100 sized to accommodate two lenses 200 and attach at each distal end thereof to a temple portion (not shown) which will rest over the user's ears. Although roughly-rectangular-shaped lenses 200 are shown in FIGS. 1 and 4, it will be understood that the subject invention can accommodate lenses of multiple different sizes and shapes, including a face shield which extends out beyond the nose bridge portion (as will be described) and down over the wearer's entire face. Also as will be understood, the general shape of the frame 100 of the inventive safety glasses can also be sized and shaped differently to accommodate such different types of lenses 100. A critical aspect of the frame 100 is that it have a bridge portion 102 sized and shaped to accommodate the metal clip 300 (see FIGS. 2 and 3), as will be described. In some preferred embodiments, bridge portion 102 is in the longitudinal center of frame 100 (situated roughly over where the user's nose would be during use).

As shown in FIGS. 1 and 4, which show the inventive glasses from the rear, frame 100 generally comprises an elongate top portion 100A, which may generally have a left section 101, the aforementioned bridge portion 102, and a right portion 103. In some preferred embodiments, such as that shown in FIGS. 1 and 4, top portion 100A may take the general shape of a very shallow “V”, in that the left 101 and right 103 portions thereof may rise slightly from the horizontal (as worn) as they extend outward from bridge portion 102. In other preferred embodiments, top portion 100A may be completely straight across the top surface thereof. As shown, a proximal end of each left 101 and right 103 portion of the top portion may be adjacent to the bridge portion 103, and the distal end of each said left 101 and right 103 portion may be designed with hinges or the like for connecting to temple portions (not shown). Although left 101, right, 103, and bridge portions of the frame may be described herein as “adjacent” or “contacting”, it will be understood that the entire top portion 100A of the frame, in preferred embodiments, is a single unitary component, which may be formed by co-molding or like processes.

With further reference to FIGS. 1 and 4, lenses 200 can take a generally quadrilateral shape, whereby the top edge conforms to, and is seated within, the left 101 and right 103 portions of the top of the frame 100A. In the embodiment shown in FIGS. 1 and 4, the sides are generally vertical, but tapered in towards the bottom edge, which is also slanted to make each lens 200 wider towards the middle of the frame (where the user's nose would generally be situated during use). It will be understood however, that the shape of the lens is not a critical aspect of the present invention, except that the lens should be of a size and shape that can cover the eyes of a standard sized adult, and preferably a slightly larger portion of the face surrounding the eyes. For example, as noted previously, the present invention can be easily adapted to applications including a full-sized face shield. Thus, it can be seen that the present invention can accommodate various lens shapes, including rectangular, oval, circular, square, various angles of quadrilateral, and the like.

As described, the portion of frame 100A where left 101 and right 103 portions join is the bridge portion 102. Bridge portion 102 has two critical characteristics according to the present invention. First, bridge portion 102 is wide enough, and thick enough (along the shortest dimension of the frame, perpendicular to the page) to accommodate the inventive metal clip 300 as will be described. In preferred embodiments, the height of bridge portion 102 is 11.36 mm, or between 8 mm and 14 mm. Second, bridge portion 102 must have two openings 21 which are specially configured to accommodate the distal ends of metal clip 300 in the manner as will be described. In preferred embodiments, bridge 102 has a thickness which is slightly larger than the thickness of the left 101 and right 103 portions of the frame 101A, and/or which is reinforced with additional material, or multiple types of material, to improve the durability of the frame as a whole, and to enable secure fit between the bridge 102 and the metal clip 103.

In some preferred embodiments, bridge 102 includes legs that extend a portion of the way down the interior edges of the lenses 200, to accommodate nose pads 22, which, in use, would rest on either side of the user's nose, enabling the safety glasses to rest comfortably on the user's face. Nose pads 22 may be of any sufficiently padded material, such as silicone or various other polymers, or felt or other cloth-type materials-any material known in the art or hereinafter discovered for use as a nose padding material may fall within the scope of the present invention.

With further reference to FIGS. 1 and 4, it can be seen that, in some embodiments, a secondary portion of frame 100 can extend around the exterior of lenses 200, this portion of the frame being denoted with reference character 101B. In other embodiments, lenses 200 are “frameless” in that the only contact point between the lenses and the frame is at the top portion of frame 101A.

With reference now to FIGS. 2 and 3, the innovative metal clip 300 is now described. As shown in the figures, the innovative clip 300 has three main portions-the main body 302, and left 301 and right 303 tabs, each of which extend at a right angle from the plain of main body portion 302, in the same direction so as to form a wide “U” shape in the clip 300 as a whole. In preferred embodiments, metal clip 300 is uniformly thick along each component. Also in preferred embodiments, the main body portion 302 is 15.8 mm long, or between 12 mm and 19 mm. In preferred embodiments, the width of the main body portion 302 is 4.53 mm, or between 2 mm and 7 mm. In preferred embodiments, the width of the main body portion 302 is 4.53 mm, or between 2 mm and 7 mm. Critically, however, the distal ends of each of left and right tabs 301 and 303, respectively, has serrated or jagged portions on at least one lateral side thereof. In preferred embodiments, the serrated portion, denoted in FIG. 2 by the reference character 301A, extends roughly ½ way down the length of each lateral edge of each tab, 301, 303 on both sides. In some embodiments, the length of serrated portion 301A, as compared with the total length of each representative tab 301, may be 25%, or 30%, or 35%, or 40%, or 45%, or 55%, or 60%, or 65%, or 70%, or 75%, or between 30 and 60%, or between 35 and 75%. In preferred embodiments, the length of each tab is 3.73 mm, or between 2 mm and 5 mm. In other embodiments, the length of the serrated portion differs between the two lateral sides of each representative tab 301. In some embodiments, the serrated portion 301A exists only on one side of each representative tab 301.

In preferred embodiments, the depth of serration is even along the length of the serrated portion 301A, as shown in FIGS. 2 and 3. However, in alternative embodiments, the depth of serration can decrease, or, in preferred alternative embodiments, increase towards the distal end of each representative tab 301. With specific reference to FIG. 3, in preferred embodiments, the width of the outermost measurement of the serrated portion, W2, is slightly shorter than the width W1 of the remainder of each representative tab 301. In preferred embodiments, the dimension W2 stays constant over the entire length of the serrated portion 301A. In other embodiments, the serrated portion 301A, or the entire representative tab 301, tapers towards the distal end thereof.

In preferred embodiments, clip 300 is constructed from Stainless Steel 430.

Critically, the interior dimension of each opening 21 in the bridge portion 102 of the frame is the inverse of the shape each tab 301, 303 of the inventive metal clip 300. Thus, the interior of each opening 21 may be etched, molded, or otherwise configured to incorporate serration that mimics the outline of each serrated portion 301A of the clip 300, such that each opening 21 will capture the tab portions 301, 303 upon insertion and hold them fast. In preferred embodiments, the bridge portion 102 also includes a corresponding groove between openings, 21, which is sized to accommodate the main body 302 of the metal clip 300 such that the exterior surface thereof can lie flush with the exterior surface of the rear of bridge 102, once the clip 300 is inserted. Thus, once tabs 301, 303 are each inserted in a corresponding opening 21, as can be seen with reference to the figures, the body 302 will extend along the back of bridge portion 102 between the openings 21 and either rest in a corresponding groove, or, in some embodiments, rest on the back surface of bridge 102. In either embodiment, however, it can be seen how the tabs 301, 303 will remain embedded in the frame 100 of the inventive safety glasses in the event that they are broken, and, because the metal material used for the clip 300 is of sufficient strength, the entire clip 300 will, under the majority of conditions, remain intact such that it can be detected by a metal detector and, if present, removed from any portion of the product or processing line in the event of an accident.

To manufacture the inventive safety glasses, the frame and lenses are first formed. Once completed, the inventive metal clip 300 may then be press-inserted by pushing the tabs 301, 303 into the corresponding openings 21 on the back of bridge portion 102.

As can be seen, the innovative safety glasses are a PPE device, or a pair of safety glasses in particular, which has a metal component securely embedded in a primary portion thereof, such that it can be detectable by metal detectors used on or in connection with a production line, such as a food production line. The present invention also provides a pair of safety glasses in which the amount of metal utilized to make the primary portion thereof detectable by a magnet is minimized, to make such device more cost effective.

This application is therefore intended to cover any variations, uses, or adaptations of the invention using its general principles. Further, this application is intended to cover such departures from the present disclosure as come within known or customary practice in the art to which this invention pertains.

I claim:

1. A pair of safety glasses, comprising:
a frame portion comprising a bridge potion; and
a metal clip securely embedded in said bridge portion;
wherein said metal clip is configured generally in a wide “U” shape.

2. The pair of safety glasses of claim 1, wherein the metal clip comprises a main body portion and two tab portions extending out at a right angle as compared with the primary plane of said main body portion.

3. The pair of safety glasses of claim 2, wherein a distal end of each tab portion is serrated.

4. The pair of safety glasses of claim 3, wherein said serration extends along a portion of each lateral side of each of said tabs.

5. The pair of safety goggles of claim 4, wherein said portion of each lateral side is between 30 and 60% of each lateral side.

6. The pair of safety goggles of claim 5, wherein said portion of each lateral side is 50%.

7. The pair of safety goggles of claim 3, wherein said bridge portion includes two openings corresponding to the shape of said distal end of each of said tab portions.

8. The pair of safety goggles of claim 1, wherein a distal portion of each side of said metal clip is serrated.

9. The pair of safety glasses of claim 8, wherein said serration extends along a portion of each lateral side of each of said distal portions of each side of said metal clip.

10. The pair of safety goggles of claim 9, wherein said portion of each lateral side is between 30 and 60% of each lateral side.

11. The pair of safety goggles of claim 10, wherein said portion of each lateral side is 50%.

12. The pair of safety goggles of claim 8. wherein said bridge portion includes two openings corresponding to the shape of said distal portions of each side of said metal clip.
